(19) United States
(12) Patent Application Publication
(10) Pub. No.: US 2009/0115229 A1
(43) Pub. Date: May 7, 2009

(54) Underseat storage

(75) Inventors: Thomas Wayne Messner, Grand Blanc, MI (US); April Lee Lampkowski, Grand Blanc, MI (US)

Correspondence Address: FOLEY AND LARDNER LLP;SUITE 500, 3000 K STREET NW, WASHINGTON, DC, 20007, US

(73) Assignee: TK Holdings Inc.

(21) Appl. No.: 12/289,700

(22) Filed: Oct. 31, 2008

Related U.S. Application Data
(60) Provisional application No. 60/996,147, filed on Nov. 2, 2007.

(51) Int. Cl. A47C 7/62; B23P 11/00; B60N 2/44; B60N 3/00; B60R 7/04

(52) U.S. Cl. 297/188.1; 29/428; 296/37.15

(57) ABSTRACT

A seat apparatus comprises a seat member with a seat bottom, a front leg, a rear leg, a seat back attached to the seat member, a seat cushion movably attached to the seat bottom, and a storage container positioned underneath the seat cushion and attached to the seat member. The seat cushion is pivotably attached to the seat bottom and configured to rotate upward to allow an occupant to access the container. The storage container may include a door to permit access to the storage container.

### CROSS-REFERENCE TO RELATED PATENT APPLICATIONS

This application claims priority to U.S. Provisional Application No. 60/996,147, filed Nov. 2, 2007, which is incorporated herein by reference in its entirety.

### BACKGROUND

The present invention relates generally to the field of under-seat storage for bench-type seats. Such bench seats are often provided, for example on vehicles, such as busses, planes, or trains. In a collision, objects carried by passengers of the vehicle, such as suitcases, backpacks and other loose articles, may be thrown through the air. Such projectile objects may pose a danger to the occupants of the vehicle.

It would be advantageous to provide a storage container for a seat that is configured to help retain loose article to reduce the likelihood that the loose articles may become projectiles in a collision.

### SUMMARY

One exemplary embodiment relates to a seat apparatus comprising a seat member with a seat bottom, a front leg, a rear leg, a seat back attached to the seat member, a seat cushion movably attached to the seat bottom, and a storage container positioned underneath the seat cushion and attached to the seat member. The seat cushion is pivotably attached to the seat bottom and configured to rotate upward to allow an occupant to access the container.

Another embodiment relates to a method of forming a storage container underneath a seat. The method comprises providing a seat including a seat member with a seat bottom, a front leg and a rear leg, and a seat cushion movable attached to the seat member. The method further comprises providing a container including a bottom panel, front and rear panels extending up from the bottom panel, and at least one side panel extending up from the bottom panel and between the front and rear panels. The method further comprises positioning the container underneath the seat cushion; attaching the container to the seat member; and pivotably attaching the seat cushion to the seat bottom such that the seat cushion can rotate upwards to allow an occupant to access the container.

It is to be understood that both the foregoing general description and the following detailed description are exemplary and explanatory only, and are not restrictive of the invention as claimed.

### BRIEF DESCRIPTION OF THE DRAWINGS

These and other features, aspects, and advantages of the present invention will become apparent from the following description, appended claims, and the accompanying exemplary embodiments shown in the drawings, which are briefly described below.

FIG. 1 is an isometric view of an interior of a vehicle showing the position of a single seat apparatus according to an exemplary embodiment.

FIG. 2 is an isometric view of a seat apparatus including a moveable seat cushion to allow access to an under-seat storage container according to an exemplary embodiment.

FIG. 3 is an isometric view of a seat apparatus including a moveable seat cushion to allow access to an under-seat storage container according to another exemplary embodiment.

FIG. 4 is an isometric view of a seat apparatus including a seat cushion with multiple moveable portions to allow access to an under-seat storage container according to another exemplary embodiment.

FIG. 5 is an isometric view of a seat apparatus including a seat cushion with multiple moveable portions to allow access to an under-seat storage container according to another exemplary embodiment.

FIG. 6 is an isometric view of a seat apparatus including a moveable seat cushion with multiple moveable hatches to allow access to an under-seat storage container according to another exemplary embodiment.

FIG. 7 is a side view of the seat apparatus of FIG. 6 showing a hatch in the seat cushion in an open position to allow access to the under-seat storage compartment.

FIG. 8 is a side view of the seat apparatus of FIG. 6 showing the seat cushion in an open position to allow access to the under-seat storage compartment.

FIG. 9 is an isometric view of a seat apparatus including a moveable seat cushion with multiple moveable hatches to allow access to an under-seat storage container according to another exemplary embodiment.

FIG. 10 is a side view of the seat apparatus of FIG. 9 showing a hatch in the seat cushion in an open position to allow access to the under-seat storage compartment.

FIG. 11 is an isometric view of a seat apparatus including an under-seat storage container according to another exemplary embodiment.

FIG. 12 is an isometric view of an under-seat storage container according to another exemplary embodiment.

FIG. 13 is an isometric view of an under-seat storage container according to another exemplary embodiment.

FIG. 14 is an isometric view of an under-seat storage container according to another exemplary embodiment.

FIG. 15 is an isometric view of an under-seat storage container according to another exemplary embodiment.

FIG. 16 is an isometric view of an under-seat storage container according to another exemplary embodiment.

FIG. 17 is an isometric view of an under-seat storage container according to another exemplary embodiment.

FIG. 18 is an isometric view of a seat apparatus including an under-seat storage container with a moveable door to allow access to the storage container according to another exemplary embodiment.

FIG. 19 is a flowchart of a method of forming a storage container underneath a seat according to an exemplary embodiment.

### DETAILED DESCRIPTION

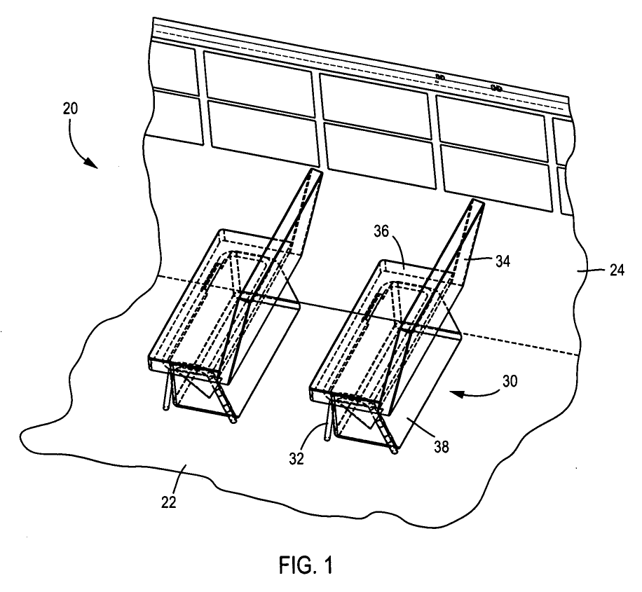

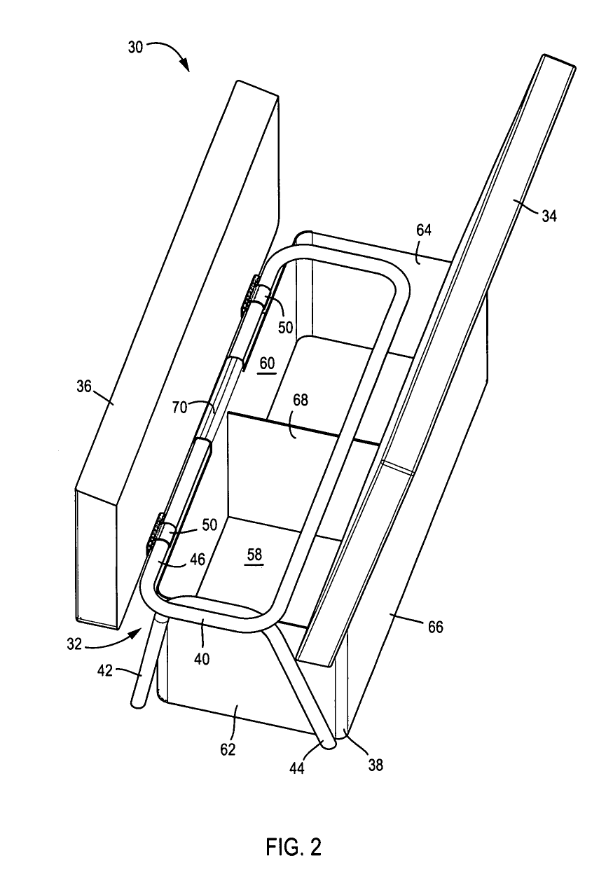

Referring to FIG. 1, a vehicle interior 20 is shown defined by a floor 22, and at least one side wall 24. The vehicle interior 20 includes at least one seat apparatus 30 according to an exemplary embodiment. Seats 30 are generally provided in rows along either side of the vehicle interior 20. As shown in FIG. 1, each of the seats 30 includes a seat member 32 (e.g., a seat frame) that supports the seat 30, a generally vertical seat back 34, a generally horizontal seat cushion 36 upon which one or more passengers may sit, and a storage container 38 provided under the seat cushion 36 and coupled to the seat member 32. The seat apparatus 30 is shown in more detail in FIGS. 2-17 according to various exemplary embodiments.

The seat member 32 is shown as generally comprising a seat bottom 40, a front leg 42, and a rear leg 44. The front leg 42 and the rear leg 44 are shown as being formed from a single tubular member that is bent into a U-shape. According to other exemplary embodiments, the front leg 42 and the rear leg 44 may be separate members. The seat member 32 is shown as a rectangular member formed from a bent tubular member. The long sides of the seat member 32 form two generally parallel cross members 46. The cross members 46 are generally aligned with the front leg 42 and the rear leg 44. The cross member is coupled to and supported by the front leg 42 and the rear leg 44 on one side (e.g., the aisle side) and by the vehicle side wall 24 on the other side (e.g., the window side).

Alternatively, the seat 30 may be free-standing and, thus, separate from the vehicle side wall 24. In such an embodiment, the seat member 32 would include a pair of front legs with a front cross member 46 extending therebetween, and a pair of rear legs with a rear cross member extending therebetween.

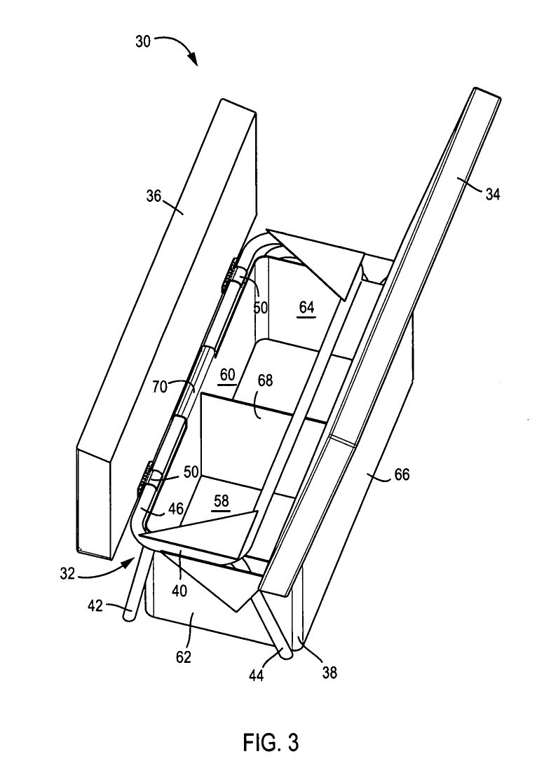

As shown in FIGS.2-10, the seat cushion 36 may move relative to the seat bottom 40. According to an exemplary embodiment, the seat cushion 36 pivots along the front edge (e.g., the edge opposite of the seat back 34, on one or more hinge members 50. The hinge members 50 are coupled to a cross member 46 of the seat bottom 40. By lifting up the rear of the seat cushion 36 (e.g., the end proximate to the seat back 34) a passenger may rotate the seat cushion 36 about the cross member 46 to allow access to the storage container 38 below the seat cushion 36. According to one exemplary embodiment, the entire seat cushion 36 pivots on the hinge members 50 together (see FIGS. 2-3).

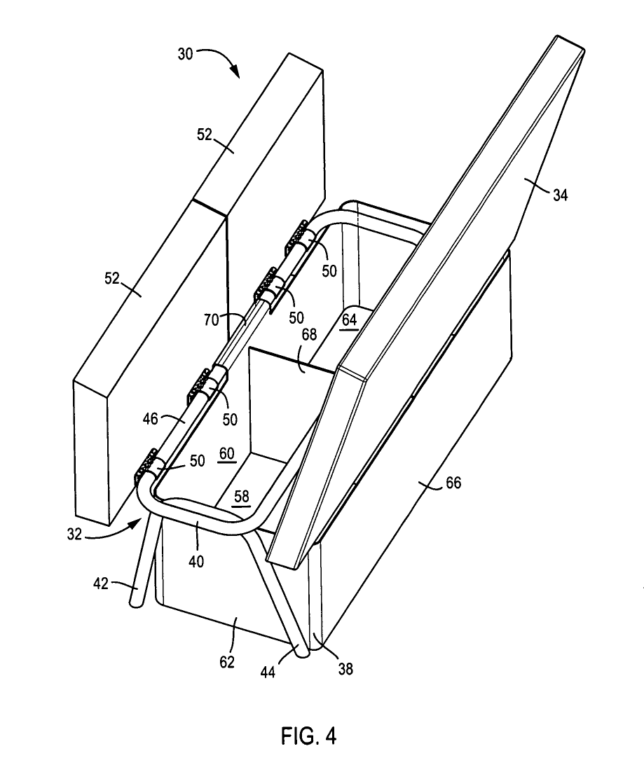

According to another exemplary embodiment, the seat cushion 36 may be divided into two or more separate seat cushion portions 52 that may be moved independently from each other (see FIGS. 4-5). While the cushion 36 in FIGS. 4 and 5 is shown as being divided in half into two fairly equal portions 52, according to other exemplary embodiments, the cushion 36 may be otherwise divided. For example, the cushion may be unevenly divided, such as a 60-40 split, or may be divided into more than two portions. A cushion 36 divided into portions 52 allows one passenger to access the storage container 38 while another passenger may remain seated.

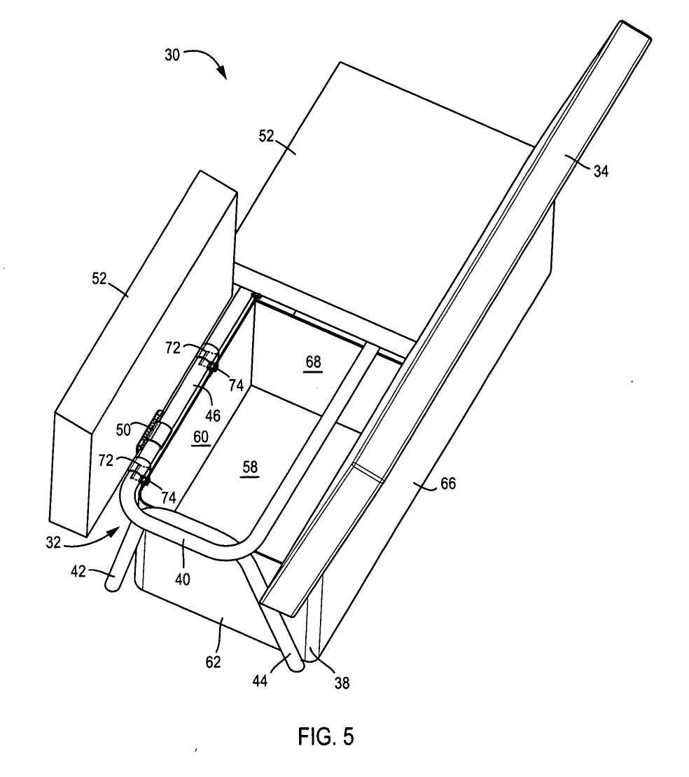

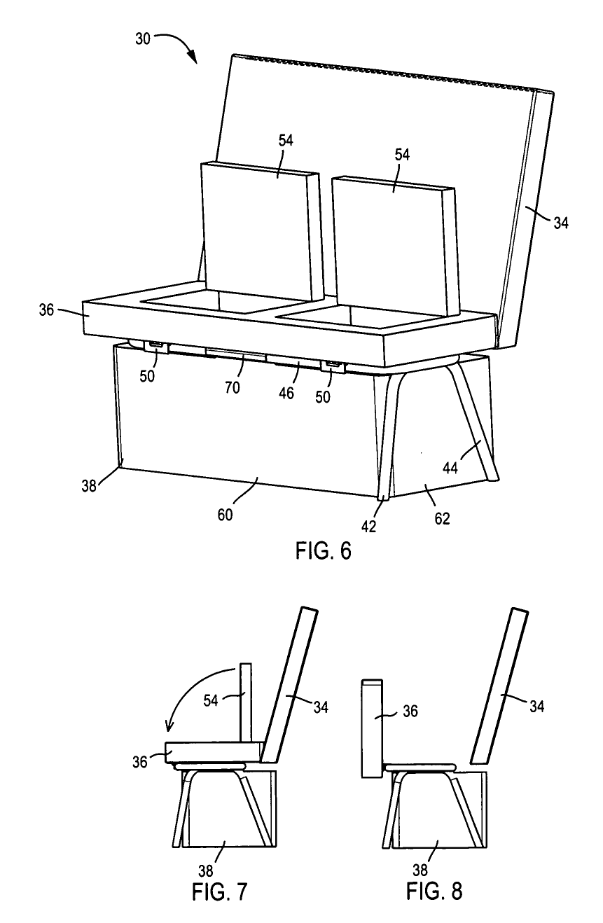

According to still other exemplary embodiments, the cushion 36 may comprise one or more hatches 54 (see FIGS. 6-10). The hatches 54 are moveable relative to the cushion 36 (e.g., hinged) to reveal openings in the cushion that allow a passenger to access the storage container 38 below the seat cushion 36. Hatches 54 may be provided in a rigidly attached seat cushion or a moveable cushion, as described in FIGS. 1-5. According to an exemplary embodiment, one hatch 54 may be provided in each portion 52 of a cushion 36. The hatches 54 may be hinged on the same side as the hinge members 50 or on the opposite side as the hinge members 50, as shown in FIGS. 6-10. Hatches 54 may allow smaller objects to be placed in and removed from the storage container 38 (see FIGS. 7 and 10) while the entire seat cushion 36 or a seat cushion portion 52 may be moved to allow larger objects to placed in or removed from the storage container 38 (see FIG. 8).

Each of the seat cushion 36, seat cushion portions 52, or hatches 54 may include a locking or latching mechanism to retain the component in the close configuration. The passenger may activate the locking mechanism to release the component and allow the passenger to move the seat cushion 36, seat cushion portions 52, or hatches 54. Such a locking mechanism reduces the likelihood that the seat cushion 36, seat cushion portions 52, or hatches 54 will be opened inadvertently.

The storage container 38 is provided below the seat cushion 36 and is configured to receive loose objects such as backpacks, suitcases, or other small articles. The storage container 38 is coupled to the seat member 32 with one or more attachment features. The attachment features are configured to couple the storage container 38 to a seat apparatus 30 without additional fasteners and without having to alter the seat apparatus 30. Instead, the storage container 38 may be added to existing suitable seats 30 in a vehicle to increase the storage capabilities of the vehicle.

According to one exemplary embodiment, shown in FIGS. 2-8, the storage container 38 is an open box-like body that comprises a floor 58, a first wall 60, a second wall 62, a third wall 64, a fourth wall 66 and a divider wall 68. The walls 60, 62, 64, 66, and 68 are vertical side walls that are generally perpendicular to the floor 58. The first wall 60, and the fourth wall 66 are perpendicular to the second wall 62, the third wall 64 and the divider wall 68. The first wall 60 is generally aligned with the front cross member 46 (e.g., opposite of the seat back 34). The second wall 62 and the third wall 64 are provided proximate to the legs 42 and 44 and to the side wall 24 of the vehicle 20, respectively. The fourth wall 66 is provided generally under the seat back 34, opposite of the first wall 60. The divider wall 68 may be provided in the interior of the storage container 38 between the second wall 62 and the third wall 64. The divider wall 68 may be aligned with the separation between the seat cushion portions 52 such that the divider wall 68 separates the storage container 38 into multiple compartments that are each generally aligned with one of the seat cushion portions 52 and/or one of the hatches 54. The divider wall 68 helps to segregate the loose articles of one passenger from the loose articles of another. While only a single divider wall 68 is shown in the FIGURES, according to other exemplary embodiments, more divider walls may be provided to divide the storage container 38 into more than two compartments (i.e., if the cushion 36 is divided into more than two seat cushion portions 52).

According to an exemplary embodiment, the floor 58, the side walls 60, 62, 64, and 66 and the divider wall 68 may be molded as a single unitary body (e.g., as an injection molded polymer body). According to other exemplary embodiments, the storage container 38 may be formed from multiple components that are coupled together (e.g., with fasteners, with snap features, etc.).

Referring now to FIG. 2-4, according to one exemplary embodiment, the attachment feature for the storage container 38 is an integrally molded clip or snap feature 70. The clip 70 extends upward from the first wall 60 and is configured to engage a cross member 46 of the seat bottom 40. According to an exemplary embodiment, the cross member 46 has a generally circular cross-section and the clip 70 has a rounded hook-like profile such that it may couple the storage container 38 to the seat bottom 40 with a snap-fit. According to one exemplary embodiment, the clip 70 may be provided as a single body. According to other exemplary embodiments, the storage container 38 may include several integrally molded clips 70 provided along the length of the first wall 60. According to other exemplary embodiments, the integrally formed clip 70 may be coupled to the second wall 62 or the fourth wall 66 to engage the seat bottom 40.

According to another exemplary embodiment, the storage container 38 may include separate clips 72 that are coupled to the storage container 38. As shown in FIG. 5, a plurality of clips 72 may be coupled to the first wall 60 of the storage container 38 with fasteners 74 (e.g., threaded fasteners, rivets, adhesives, etc.). The clips 72 may be coupled to the storage container 38 before the storage container is transported to the vehicle to be installed in the vehicle interior 20.

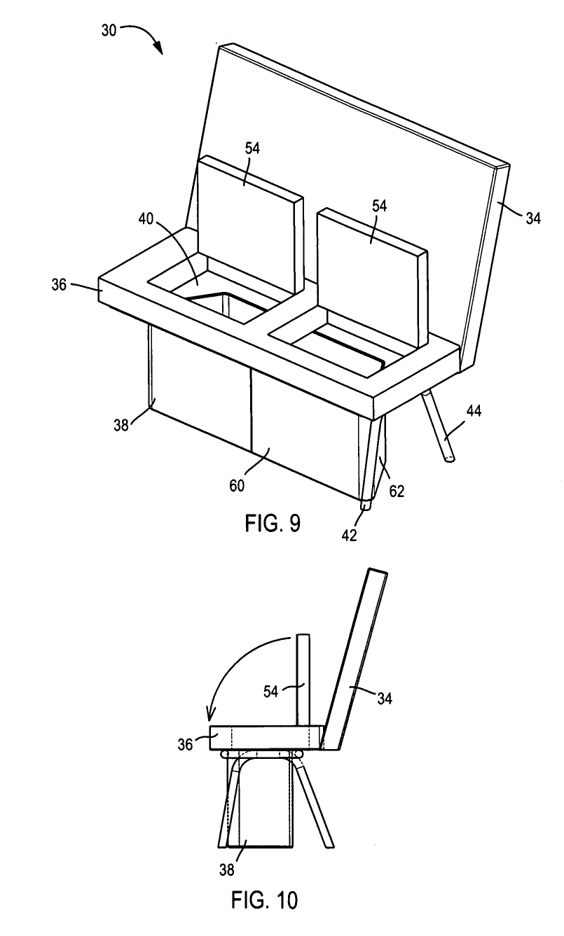

Referring now to FIGS. 9-10, according to another exemplary embodiment, the storage container 32 and the seat cushion 36 may be manufactured as a modular unit. The storage container 32 may be shaped such that the storage container 38 and seat cushion 34 assembly may be lowered onto an existing seat apparatus 30. For example, the second wall 62 and the third wall 64 of the storage container may be slanted such that they are not parallel to each other to accommodate diagonal bracing reinforcing the seat member 32.

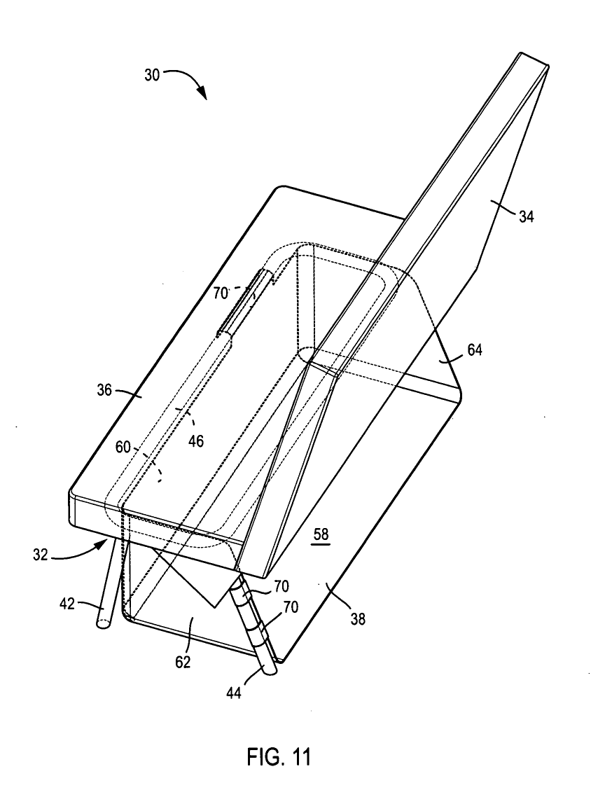

Referring now to FIGS. 11-17, according to other exemplary embodiments, the storage container 38 may be configured to be accessed by the occupants of a seat apparatus 30 provided behind the seat apparatus 30 to which the storage container 38 is coupled. As such, the storage container 38 may not include a fourth or rear wall so that the occupants of the seat apparatus 30 behind the storage container 38 may access the storage container 38 and place loose articles into the storage container 38.

As shown in FIG. 11, a storage container 38 is shown according to an exemplary embodiment including a floor 58, a first wall 60, a second wall 62, and a third wall 64. The storage container is coupled to the seat member 32 with an integrally formed clips 70. One clip 70 couples the first wall 60 to the cross member 46. Unlike the clip 70 shown in FIG. 2, the clip of FIG. 11 is not located proximate to the middle of the first wall 60 but is instead located to one side (e.g., closer to the third wall 64). One or more additional clips 70 couple the second wall 62 to the rear leg 44. By providing the clip 70 on the first wall 60 proximate to the third wall 64 and remote from the second wall 62, the clips 70 are less likely to act as pivot points about which the storage container 38 may rotate.

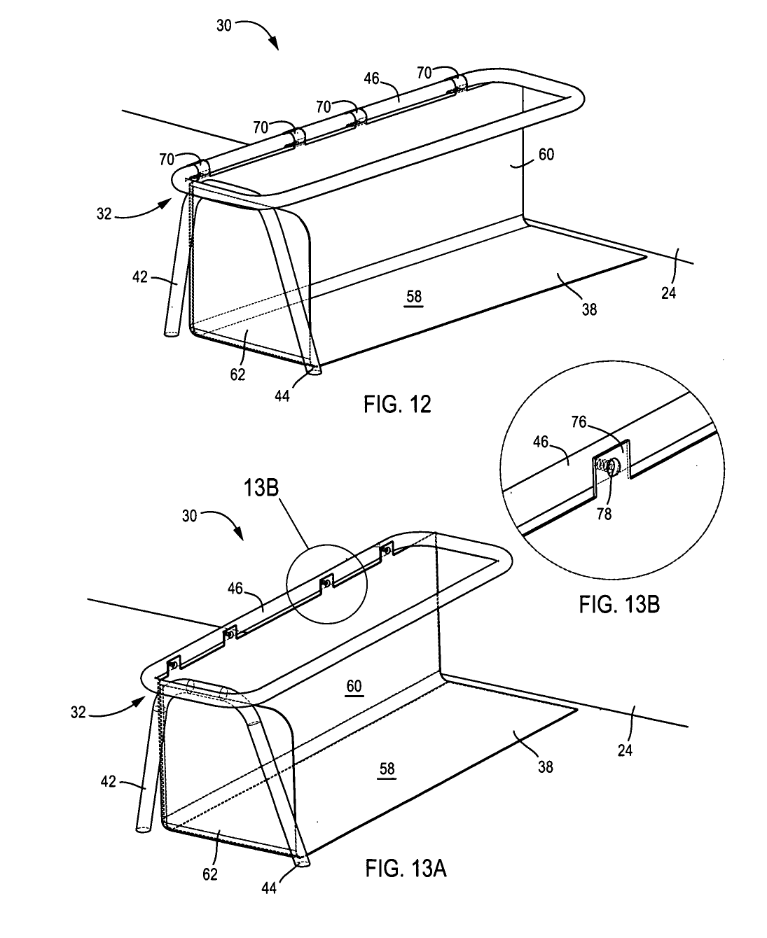

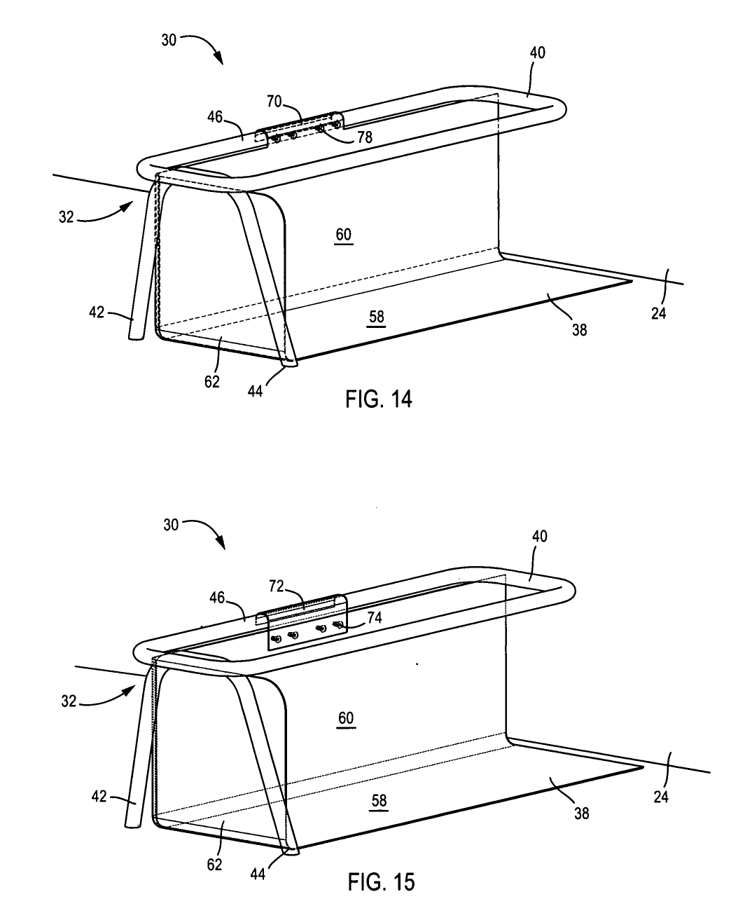

As shown in FIGS. 12-15, a storage container 38 is shown according to an exemplary embodiment including a floor 58, a first wall 60, and a second wall 62. The side wall 24 of the vehicle provides the third wall for the storage container 38. According to one exemplary embodiment, a plurality of integrally formed clips 70 couple the first wall 60 to a cross member 46 (see FIG. 12). According to another exemplary embodiment, a plurality of tabs 76 (e.g., extensions, protrusions, etc.) extend upward from the first wall, generally aligned with pre-existing holes or slots in the cross member 46 (see FIGS. 13A-13B). The holes or slots may be added separately by an appropriate tool. The tabs 76 are coupled to the cross member with fasteners such as push-pin fasteners 78. The push pins fasteners do not require additional tools and may be pushed in by hand to engage the cross member 46 and quickly and easily couple the storage container 38 to the seat member 32. According to another exemplary embodiment, the storage container 38 may be coupled to the cross member 46 with an integrally formed clip 70 that is reinforced with one or more push-pin fasteners 78 (see FIG. 14). According to another exemplary embodiment, the storage container 38 may be coupled to the cross member 46 with a separate clip 72 that coupled to the first wall 60 with fasteners 74 (see FIG. 15).

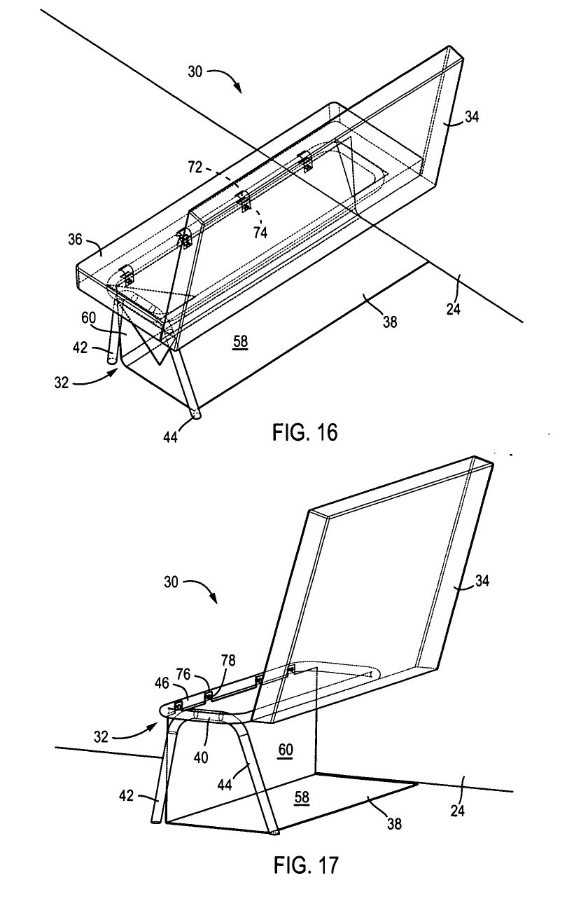

As shown in FIGS. 16-17, a storage container 38 is shown according to an exemplary embodiment including a floor 58 and a first wall. The side wall 24 of the vehicle provides the third wall for the storage container 38 and the opposite side is left open. According to one exemplary embodiment, a plurality of separate clips 72 are coupled to the first wall 60 with fasteners 74. The clips 72 couple the first wall 60 to a cross member 46 (see FIG. 16). According to another exemplary embodiment, a plurality of tabs 76 (e.g., extensions, protrusions, etc.) extend upward from the first wall, generally aligned with pre-existing holes in the cross member 46 (see FIGS. 17). The tabs 76 are coupled to the cross member with fasteners such as push-pin fasteners 78.

It should be recognized that the storage container 38 can be modified by varying the number and position of walls. For example, the container 38 need not contain a bottom wall. Rather, the floor of the vehicle is used as the bottom of the container 38.

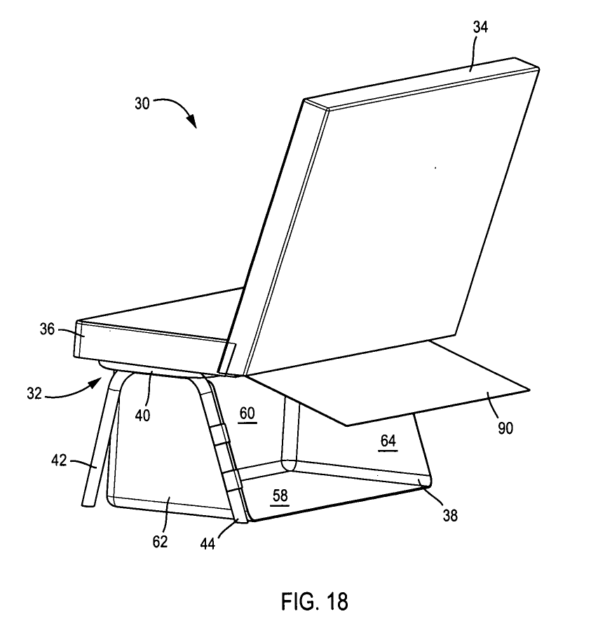

According to another embodiment shown in FIG. 18, the storage container 38 may have a movable door 90 to access the container 38. According to one exemplary embodiment, the door 90 is provided to close the back side of the storage container 38 such that an occupant sitting behind the seat 30 with the container 38 can open the (pivoting or movable) door in the container 38 to gain access to the container 38. According to other exemplary embodiments, the door 90 may be provided on a side wall of the container 38 or may be positioned below the seat cushion 36 in a top wall of the container 38. The door 90 can be a pivoting door, a tambour-type door, a sliding pocket-style door, or any other suitable type of door.

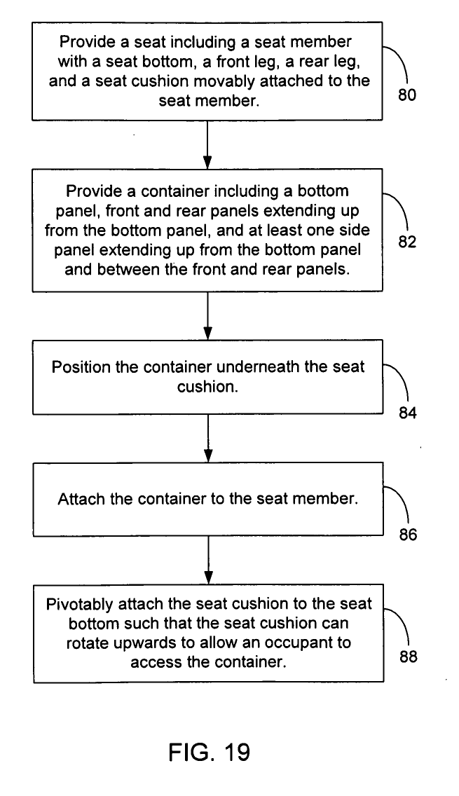

Referring to FIG. 19, a method of forming a storage container underneath a seat is shown according to an exemplary embodiment. In a first step 80, a seat is provided, the seat including a seat member with a seat bottom, a pair of front and rear legs, and a seat cushion movably attached to the seat member. In a second step 82, a container is provided, the container including a bottom panel, front and rear panels extending up from the bottom panel, and at least one side panel extending up from the bottom panel and between the front and rear panels. In a third step 84, the container is positioned underneath the seat cushion. In a fourth step 86, the container is attached to the seat member. In a fifth step 88, the seat cushion is pivotably attached to the seat bottom such that the seat cushion can rotate upwards to allow an occupant to access the container.

It should be noted that the seat 30 can be positioned in a vehicle, such as a bus, or a plane, train, or in any other suitable location. Furthermore, the seat 30 can be a single occupant-type seat with a storage container 38. The seat 30 can be any suitable type of seat, such as a bench, captain-style, etc., and canconfigured to host any suitable number of occupants.

It is important to note that the construction and arrangement of the seat apparatus as shown in the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter disclosure herein. For example, elements shown as integrally formed may be constructed of multiple parts or elements, the position of elements may be reversed or otherwise varied, and the nature or number of discrete elements or positions may be altered or varied. Accordingly, all such modifications are intended to be included within the scope of the present application. The order or sequence of any process or method steps may be varied or re-sequenced according to alternative embodiments. Other substitutions, modifications, changes and omissions may be made in the design, operating conditions and arrangement of the exemplary embodiments.

What is claimed is:

1. A seat apparatus, comprising:
a seat member with a seat bottom, a front leg, and a rear leg;
a seat back attached to the seat member;
a seat cushion movably attached to the seat bottom; and
a storage container positioned underneath the seat cushion and attached to the seat member,
wherein the seat cushion is pivotably attached to the seat bottom and configured to rotate upward to allow an occupant to access the container.

2. The seat apparatus of claim 1, wherein the container includes first, second, and third side walls extending upwards from a bottom panel.

3. The seat apparatus of claim 2, wherein a fourth side wall of the container is formed by a vehicle side wall.

4. The seat apparatus of claim 2, further comprising a fourth side wall extending upward from the bottom panel.

5. The seat apparatus of claim 1, wherein the seat cushion includes a plurality of seat cushion portions, and each seat cushion portion is independently movable relative to the other seat cushion portions.

6. The seat apparatus of claim 1, further comprising a divider wall to separate the container into a plurality of storage compartments.

7. The seat apparatus of claim 1, wherein the container attaches to a seat bottom cross-member with at least one attachment member.

8. The seat apparatus of claim 7, wherein the container is releasably attached to the seat bottom cross member by a releasable attachment member.

9. The seat apparatus of claim 8, wherein the releasable attachment member is a snap feature.

10. The seat apparatus of claim 9, wherein the snap feature is integrally formed with a side wall of the container.

11. The seat apparatus of claim 9, wherein the snap feature is attached to a side wall of the container by a fastener.

12. The seat apparatus of claim 7, wherein the seat bottom cross member extends along a front of the seat bottom between front legs.

13. The seat apparatus of claim 7, wherein the seat cushion is configured to pivot about the seat bottom cross member.

14. The seat apparatus of claim 1, wherein the seat cushion includes at least one movable hatch.

15. A method of forming a storage container underneath a seat, comprising:
providing a seat including a seat member with a seat bottom, a front leg and a rear leg, and a seat cushion movably attached to the seat member;
providing a container including a bottom panel, front and rear panels extending up from the bottom panel, and at least one side panel extending up from the bottom panel and between the front and rear panels;
positioning the container underneath the seat cushion;
attaching the container to the seat member; and
pivotably attaching the seat cushion to the seat bottom such that the seat cushion can rotate upwards to allow an occupant to access the container.

16. The method of claim 15, wherein attaching the container to the seat member includes attaching the front panel to a seat bottom cross member.

17. The method of claim 15, wherein attaching the container to the seat member includes attaching one end of a snap feature to the front panel of the container and attaching the other end of the snap feature to a seat bottom cross member.

18. The method of claim 17, wherein the container is releasably attached to the seat member via the snap feature.

19. The method of claim 17, further comprising integrally forming the snap feature to the front panel.

20. The method of claim 16, wherein attaching the front panel to the seat bottom cross member includes attaching a push pin fastener to the front panel and cross member.

21. The method of claim 15, further comprising providing a divider wall in the container to form a plurality of storage compartments.

22. A seat apparatus, comprising:
a seat member with a seat bottom, a front leg, and a rear leg;
a seat back attached to the seat member;
a seat cushion attached to the seat bottom; and
a storage container positioned underneath the seat cushion and attached to the seat member, the storage container including a front wall, rear wall, and at least one side wall, and wherein the storage container includes a moveable door configured to allow access to the storage container.

23. The seat apparatus of claim 22, wherein the rear wall includes a pivoting door.
